(19) United States
(12) Patent Application Publication
(10) Pub. No.: US 2016/0011103 A1
(43) Pub. Date: Jan. 14, 2016

(54) OPTICAL MEASURING METHOD AND MANUFACTURING METHOD OF THE ALCOHOL

(71) Applicants: Sumitomo Electric Industries, Ltd., Osaka-shi (JP); National University Corporation Kobe University, Kobe-shi (JP)

(72) Inventors: Tetsu MORISHIMA, Yokohama-shi (JP); Akihiko KONDO, Kobe-shi (JP); Tomohisa HASUNUMA, Kobe-shi (JP); Akihito NAKANISHI, Kobe-shi (JP)

(21) Appl. No.: 14/793,539

(22) Filed: Jul. 7, 2015

(30) Foreign Application Priority Data
Jul. 8, 2014 (JP) 2014-140629

(51) Int. Cl. G01N 21/3577; G01N 21/359; G01N 21/47

(52) U.S. Cl. CPC G01N 21/3577; G01N 21/4738; G01N 21/359; G01N 2021/4769

(57) ABSTRACT

An optical measuring method for measuring a concentration of a fermentation inhibitor included in a biomass-derived fermentation raw material includes acquiring a diffuse reflection spectrum or a transmission spectrum relating to a measurement target 40 which includes the biomass-derived fermentation raw material by radiating near-infrared light to the measurement target 40, and computing the concentration of the fermentation inhibitor based on the diffuse reflection spectrum or the transmission spectrum.

### TECHNICAL FIELD

The present invention relates to an optical measuring method and a manufacturing method of an alcohol, and particularly to a method for optically measuring a measurement target which includes a biomass-derived fermentation raw material and a manufacturing method of an alcohol to which the optical measuring method is applied.

### BACKGROUND

Research on manufacturing methods of bio-ethanol (biomass ethanol) that uses biomass such as sugar cane or corn as raw materials has been conducted. In particular, evaluation in each step of a manufacturing process has been increasingly conducted in recent years in order to realize enhancement of energy yield and low costs. For example, Non Patent Literature 1 mentioned below introduces analysis of a saccharified solution that is obtained by saccharifying a cellulose-derived raw material using an HPLC method.

Non Patent Literature 1: “Special Issue: Environment and Materials (1)—Analytic evaluation in manufacturing of biofuels” Toray Research Center, Inc., The TRC News No. 111 (July 2010), p. 15 to p. 21.

### SUMMARY

In the analysis using the HPLC method, the content of a component included in the saccharified solution and the like can be accurately obtained. However, since a saccharified solution needs to be extracted and subjected to predetermined pre-treatment for analysis in the HPLC method, it is not possible to use the saccharified solution that has been used in the analysis in later steps as in destructive testing. In addition, since analysis of one specimen in the HPLC method generally takes several to tens of minutes, it is difficult to evaluate many samples in real time.

The present invention has been made in view of such points, and an object thereof is to provide an optical measuring method in which a biomass-derived fermentation raw material can be evaluated with a simpler operation and a manufacturing method of an alcohol to which the optical measuring method is applied.

The invention of the present application relates to an optical measuring method for measuring a concentration of a fermentation inhibitor included in a biomass-derived fermentation raw material. The method includes: acquiring a diffuse reflection spectrum or a transmission spectrum relating to a measurement target which includes the biomass-derived fermentation raw material by radiating near-infrared light to the measurement target; and computing the concentration of the fermentation inhibitor based on the diffuse reflection spectrum and the transmission spectrum.

According to the present invention, an optical measuring method in which a biomass-derived fermentation raw material can be evaluated with a simpler operation and a manufacturing method of an alcohol to which the optical measuring method is applied are provided.

### BRIEF DESCRIPTION OF THE DRAWINGS

FIG 1 is a schematic configuration diagram of an optical measuring device according to an embodiment.

FIG. 2 is a flowchart describing a manufacturing process of bio-ethanol.

FIG. 3A and FIG. 3B show results obtained by performing a second order differential on a spectrum obtained through measurement performed by the optical measuring device.

FIG. 4A is a graph showing the correspondence between reference values and predicted values of formic acid when an analysis wavelength thereof is set in the range of 1550 nm to 1800 nm, FIG. 4B is a graph showing the correspondence when an analysis wavelength thereof is set in the range of 2150 nm to 2300 nm, and FIG. 4C is a graph showing the correspondence when an analysis wavelength thereof is set in the ranges of 1550 nm to 1800 nm and 2150 nm to 2300 nm.

FIG. 5A is a graph showing the correspondence between reference values and predicted values of furfural when an analysis wavelength thereof is set in the range of 1550 nm to 1800 nm, FIG. 5B is a graph showing the correspondence when an analysis wavelength thereof is set in the range of 2150 nm to 2300 nm, and FIG. 5C is a graph showing the correspondence when an analysis wavelength thereof is set in the ranges of 1550 nm to 1800 nm and 2150 nm to 2300 nm.

FIG. 6A is a graph showing the correspondence between reference values and predicted values of acetic acid when an analysis wavelength thereof is set in the range of 1550 nm to 1800 nm, FIG. 6B is a graph showing the correspondence when an analysis wavelength thereof is set in the range of 2150 nm to 2300 nm, and FIG. 6C is a graph showing the correspondence when an analysis wavelength thereof is set in the ranges of 1550 nm to 1800 nm and 2150 nm to 2300 nm.

### DETAILED DESCRIPTION

Description of an embodiment of the invention of the present application:

First, an embodiment of the invention of the present application will be described.

The present application provides (1) an optical measuring method for measuring a concentration of a fermentation inhibitor included in a biomass-derived fermentation raw material. The method includes acquiring a diffuse reflection spectrum or a transmission spectrum relating to a measurement target which includes the biomass-derived fermentation raw material by radiating near-infrared light to the measurement target, and computing the concentration of the fermentation inhibitor based on the diffuse reflection spectrum or the transmission spectrum.

According to the optical measuring method described above, the amount of the fermentation inhibitor may be computed based on the transmission spectrum obtained by a detection unit 20 by radiating near-infrared light from a light source 10 to the measurement target which includes the biomass-derived fermentation raw material. In addition, with the method described above, measurement can be performed with a simpler operation than when a measuring method such as the HPLC method is used as in the past. Moreover, when a biomass-derived fermentation raw material is used as a measurement target, preparation, for example, mixing the material with a drug is unnecessary and further evaluation can be performed simply using the method described above.

(2) In addition, the near-infrared light may include light with a wavelength that is included at least in the wavelength range of 1550 nm to 1800 nm. Since a characteristic peak of the fermentation inhibitor is formed in this wavelength range, the concentration of the fermentation inhibitor may be computed more accurately by performing measurement using the wavelength range.

(3) In addition, the computing the concentration may comprise computing the concentration of the fermentation inhibitor with multivariate analysis. In the computing the concentration, the concentration of the fermentation inhibitor can be computed with higher accuracy using multivariate analysis.

(4) In addition, the fermentation raw material may be a saccharified solution obtained by saccharifying cellulose. The optical measuring method according to the present invention is particularly useful when a saccharified solution obtained by saccharifying cellulose is used as a fermentation raw material.

(5) The present application also provides a manufacturing method of an alcohol. The method includes the optical measuring method described in one of (1) to (4), and adjusting, based on the concentration of the fermentation inhibitor, a condition of a pre-treatment step performed before obtaining the fermentation raw material or a fermentation condition of the fermentation raw material.

By adjusting the condition of the pre-treatment step performed until the fermentation raw material is obtained or the fermentation condition of the fermentation raw material based on the concentration of the fermentation inhibitor as described above, fermentation of the fermentation raw material can be performed under a more preferable condition.

(6) In addition, the fermentation inhibitor may include formic acid, furfural, or acetic acid. The manufacturing method of an alcohol to which the optical measuring method according to the present invention is applied is particularly useful when the fermentation inhibitor includes formic acid, furfural, or acetic acid.

Details of the embodiment of the invention of the present application:

A detailed example of the optical measuring method according to the present invention will be described hereinbelow with reference to the drawings. It should be noted that the present invention is not limited to the example, but is elucidated in the claims, and all modifications made within the gist and the scope equivalent to those of the claims are also included.

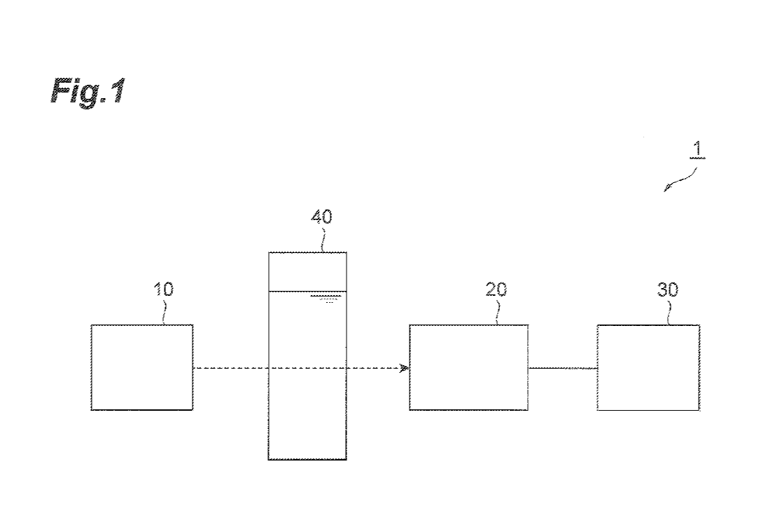

FIG. 1 is a diagram illustrating a configuration of an optical measuring device 1 according to an embodiment. The optical measuring device 1 illustrated in FIG. 1 is a device which performs measurement with respect to a measurement target 40 by radiating light emitted from the light source 10 to the measurement target 40 and detecting the transmitted light with the detection unit 20, and includes the light source 10, the detection unit 20, and an analysis unit 30.

As the measurement target 40 on which the measurement is performed by the optical measuring device 1, a sample including a fermentation raw material which is derived from biomass is exemplified. That is to say, the optical measurement performed by the optical measuring device 1 according to the present embodiment is a measurement for an intermediate product of a manufacturing process of a biomass-derived alcohol such as bio-ethanol.

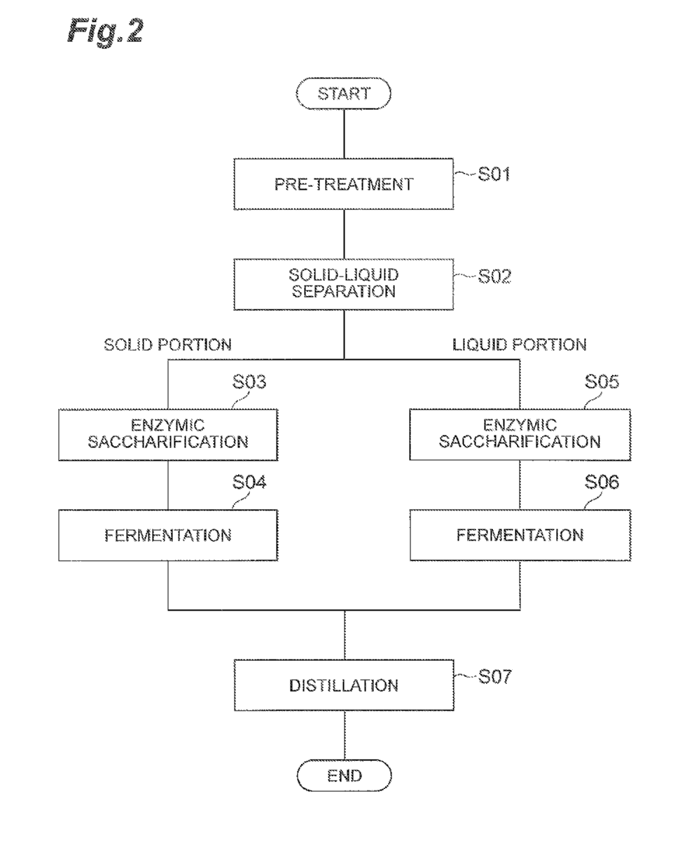

An overview of a manufacturing method of a bio-ethanol that is one of alcohols derived from biomass will be described with reference to FIG. 2. Herein, a case in which bio-ethanol is produced from so-called cellulose-based biomass such as corn stover, bagasse, rice straw, and the like will be described. First, after raw materials composed of cellulose-based biomass are pulverized, pre-treatment is performed thereon (S01). The pre-treatment is a step for the purpose of promoting saccharification of cellulose and the like in a later saccharification step, and for example, hydrothermal treatment and the like are exemplified. The raw materials after the pre-treatment are divided into solid portions and liquid portions through solid-liquid separation (S02). After an enzymic saccharification step (S03) is performed by mixing the solid portions with microorganisms which produce an enzyme (cellulase), a fermentation step (S04) using hexoses is performed. In addition, after another enzymic saccharification step (S05) is performed by mixing the liquid portions with microorganisms which produce an enzyme (hemicellulase), another fermentation step (S06) using pentose is performed. By distilling fermented liquids that have undergone the fermentation steps together (S07), bio-ethanol is obtained.

The measurement target 40 is particularly a raw material of the liquid portion of the biomass-derived fermentation raw material. Specifically, it is the saccharified solution after the enzymic saccharification step (S05). This saccharified solution includes biomass raw materials (hemicellulose, cellulose, lignin, and the like), hydrolysates thereof (xylose, galactose, glucose, and the like), microorganisms, and an over-decomposed product produced when hydrolysis using an enzyme has excessively progressed in the enzymic saccharification step. Among these, a substance that is an evaluation target for the optical measuring device 1 is the over-decomposed product. The over-decomposed product is an organic impurity composed of low-molecular organic substances, and includes fermentation inhibitors which inhibit fermentation of ethanol in the fermentation step of the later stage. As representative fermentation inhibitors with respect to a fermentation raw material obtained from cellulose-based biomass, for example, formic acid (formate), furfural, acetic acid, and the like are exemplified.

When the fermentation inhibitors inhibit conversion of sugars included in the fermentation raw material into ethanol, there is a possibility of the yield and quality of ethanol obtained from distillation deteriorating. Thus, by evaluating the content of fermentation inhibitors included in a saccharified solution in advance, the quality of the saccharified solution (whether or not the yield of ethanol after the fermentation is high) can be estimated before the fermentation begins. This point will be described below.

The light source 10 radiates near-infrared light to the region in which the measurement target 40 is disposed. As the light source 10, a halogen lamp or the like can be used. In addition, as the light source 10, an SC light source which has a seed light source and a non-linear medium, inputs light emitted from the seed light source into the non-linear medium, and widens a spectrum to a wide band in the non-linear medium utilizing a non-linear optical effect and outputs the spectrum as supercontinuum (SC) light can also be used. When the SC light source is used as the light source 10, heating with the SC light source is reduced more than with a halogen lamp, and thus it is preferably used in measuring the measurement target 40 which includes photosynthetic microorganisms. Furthermore, the light source 10 may have a function of modulating intensity. In addition, as the light source 10, an LED or an SLD light source can also be employed. With such light sources, illuminating light having a wavelength characteristic controlled beforehand is realized. At the same time, heating can also be avoided.

It should be noted that the near-infrared light that the light source 10 radiates in the present embodiment is light in a wavelength range of 800 nm to 2500 nm. Particularly, when the fermentation inhibitors are evaluated, it is preferable to use light of a wavelength band that is included in at least one of wavelength ranges of 1550 nm to 1800 nm and 2150 nm to 2300 nm, and particularly preferable to use light of a wavelength band that is included in the wavelength range of 1550 nm to 1800 nm. In addition, in the present embodiment, a spectrum refers to information including light intensity relating to at least two wavelengths.

The detection unit 20 detects light that has been transmitted through the measurement target 40 of the near-infrared light radiated from the light source 10 as a transmission spectrum. Information of the detected transmission spectrum is sent to the analysis unit 30. As the detection unit 20, for example, an MCT detector which includes mercury, cadmium, and tellurium, an InGaAs detector, or the like can be used. It should be noted that, in place of the transmission spectrum, light that has been diffusedly reflected on the measurement target 40 may be detected as a diffuse reflection spectrum.

In addition, the detection unit 20 may be a hyperspectral sensor which acquires hyperspectral images. A hyperspectral image is an image in which one pixel includes data of N wavelengths and each pixel includes spectrum information including reflection intensity data corresponding to a plurality of wavelengths. That is to say, a hyperspectral image is three-dimensionally configured data having a two-dimensional element as an image and an element as spectrum data together due to the characteristic that each pixel constituting the image has intensity data of a plurality of wavelengths. It should be noted that, in the present embodiment, a hyperspectral image refers to an image constituted by pixels each holding intensity data of at least five wavelength bands. In the embodiment to be provided below, a case in which the detection unit 20 is a hyperspectral sensor will be described.

The analysis unit 30 receives information of the transmission spectrum sent from the detection unit 20, and performs arithmetic processing. Elicitation of an absorption spectrum, elicitation of the second order differential spectrum of the transmission spectrum, elicitation of the second order differential spectrum of the absorption spectrum, and the like are performed by the analysis unit 30. Further, statistical processing for performing evaluation relating to a fermentation inhibiting substance and the like may be performed by the analysis unit 30. In addition, when the detection unit 20 is a hyperspectral sensor, information of spectra relating to respective pixels is sent to the analysis unit 30, and thus arithmetic operations on the spectrum information can be performed by the analysis unit 30.

The optical measuring method used by the optical measuring device 1 having the above-described configuration includes an acquisition step of acquiring a transmission spectrum or a diffuse reflection spectrum relating to a measurement target which includes a biomass-derived fermentation raw material by radiating near-infrared light to the measurement target, and a computation step of computing the concentration of a fermentation inhibitor that is an evaluation target based on the spectrum obtained in the acquisition step.

Specifically, near-infrared light is radiated from the light source 10 to the measurement target 40. The near-infrared light radiated from the light source 10 is incident on the measurement target 40. The near-infrared light that has been transmitted through the measurement target 40 reaches the detection unit 20. In the detection unit 20, the transmission spectrum is acquired (the acquisition step). The transmission spectrum acquired by the detection unit 20 is sent to the analysis unit 30, and in the analysis unit 30, a process relating to computation of the concentration of a fermentation inhibitor is performed (the computation step). It should be noted that the quantity of representative substances known as fermentation inhibitors can be satisfactorily computed from the spectrum obtained through the radiation of the near-infrared light.

The result of the computation of the concentration of the fermentation inhibitors can be applied to controlling of treatment of a biomass-derived fermentation raw material performed in earlier and later stages. For example, when the concentration of the fermentation inhibitors is higher than expected, it indicates that over-decomposition was occurring in the enzymic saccharification step that is the step performed before the fermentation raw material is obtained, and thus adjusting a condition for the saccharification step, the earlier pre-treatment step, or the like is considered. In addition, performing the fermentation step after lowering the concentration of the saccharified solution in a later stage in order to lower the concentration of the fermentation inhibitors is considered. In addition, when the concentration of the fermentation inhibitors is lower than expected, there is a possibility of the concentration of the fermentation raw material being low as well, and thus performing the fermentation step after concentrating the fermentation raw material is also considered. In this way, if the concentration of the fermentation inhibitors can be computed, the manufacturing processes of the former or later stage can be adjusted.

Measuring the concentration of the fermentation inhibitors included in the saccharified solution and utilizing it in adjustment of the processes can also be applied to evaluation that uses the existing HPLC method. However, when the HPLC method is used, it takes a substantial amount of time to measure one specimen, and thus it is difficult to measure and evaluate a plurality of specimens. Even when pre-treatment and saccharification are performed on biomass-derived fermentation raw materials under the same condition, saccharification progressing states substantially vary depending on the original states of the respective raw materials, and thus the nature of the saccharified solution is considered to have been changed. For this reason, although there is a demand to acquire information of the concentration of the fermentation inhibitors as simply as possible while ensuring a certain degree of accuracy, the HPLC method, despite ensuring high accuracy, has a problem in that it has many steps and requires a long period of time for measurement. On the other hand, as a method that requires a shorter measurement time than the HPLC method, the optical measuring method according to the present embodiment requires a simple step of preparing a sample for measurement and exhibits an effect of performing measurement of the concentration of fermentation inhibitors with high accuracy.

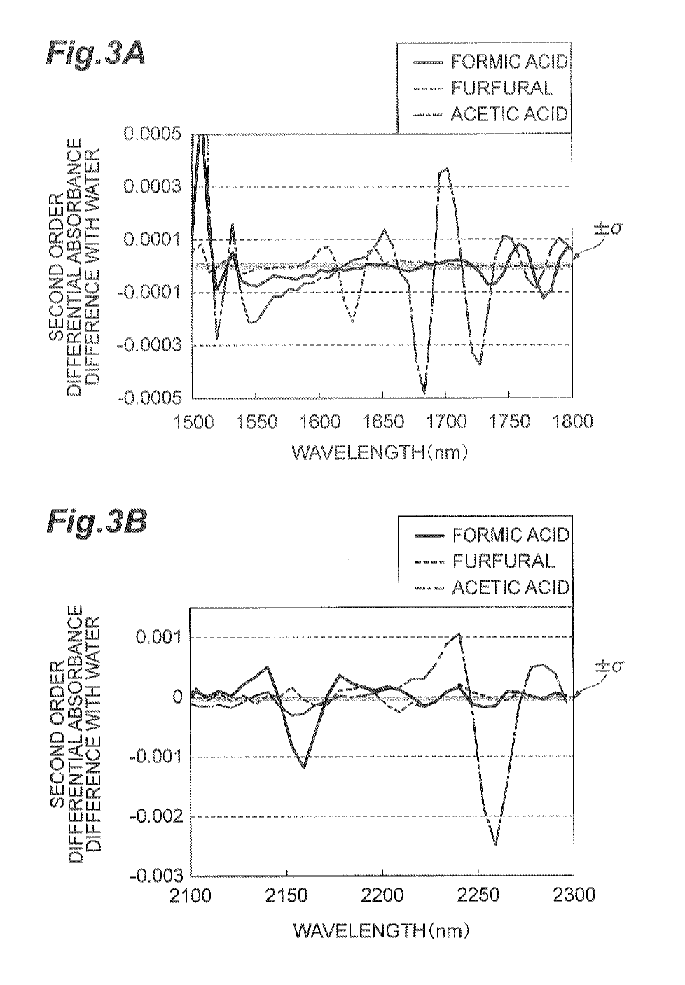

Herein, examples in which the concentrations of the fermentation inhibitors have been measured using a fermentation raw material which includes the fermentation inhibitors serving as the measurement target 40 will be described with reference to FIGS. 3 to 6.

In FIGS. 3A and 3B, results obtained by preparing samples in which the fermentation inhibitors are added to a saccharified solution that has been obtained by saccharifying cellulose and measuring transmission spectra thereof are shown. For the saccharified solution, napier grass was pulverized, pre-treatment was performed thereon, a pre-treated product obtained therefrom was divided into solids and liquids, the liquid portions underwent enzymic saccharification, and thereby a liquid was prepared. Three samples of this saccharified solution were prepared, and formic acid, furfural, and acetic acid were added thereto as fermentation inhibitors. The range of the measurement wavelength of near-infrared light emitted from the light source 10 was set from 1000 nm to 2500 nm. In FIGS. 3A and 3B, after the transmission spectra were converted into absorption spectra, they were subjected to a second order differential, and the wavelength range of 1500 nm to 1800 nm is shown in FIG. 3A and the wavelength range of 2100 nm to 2300 nm is shown in FIG. 3B. It should be noted that, in FIGS. 3A and 3B, the average of the spectrum data of each pixel sent from the detection unit 20 which is a hyperspectral sensor is obtained by the analysis unit 30, that is to say, the average absorption spectrum of all pixels has undergone the second order differential.

As shown in FIGS. 3A and 3B, it was found that formic acid has characteristic peaks near the wavelengths of 1777 nm and 2159 nm. In addition, it was found that furfural has a characteristic peak near the wavelength of 1626 nm. In addition, it was found that acetic acid has characteristic peaks at the wavelengths of 1683 nm, 1727 nm, and 2259 nm. Thus, by obtaining the correspondence between the concentrations of the respective fermentation inhibitors and the absorbance thereof at the peaks in advance, a configuration in which an absorption spectrum of near-infrared light is acquired for a measurement target of which the content (concentration) of the fermentation inhibitors is unknown and the concentration of the fermentation inhibitors based on the absorbance near the specific wavelengths is computed can be realized.

In addition, since the wavelength bands having the characteristic peaks vary according to the types of fermentation inhibitors, the content of only a specific component among fermentation inhibitors included in the samples can also be measured.

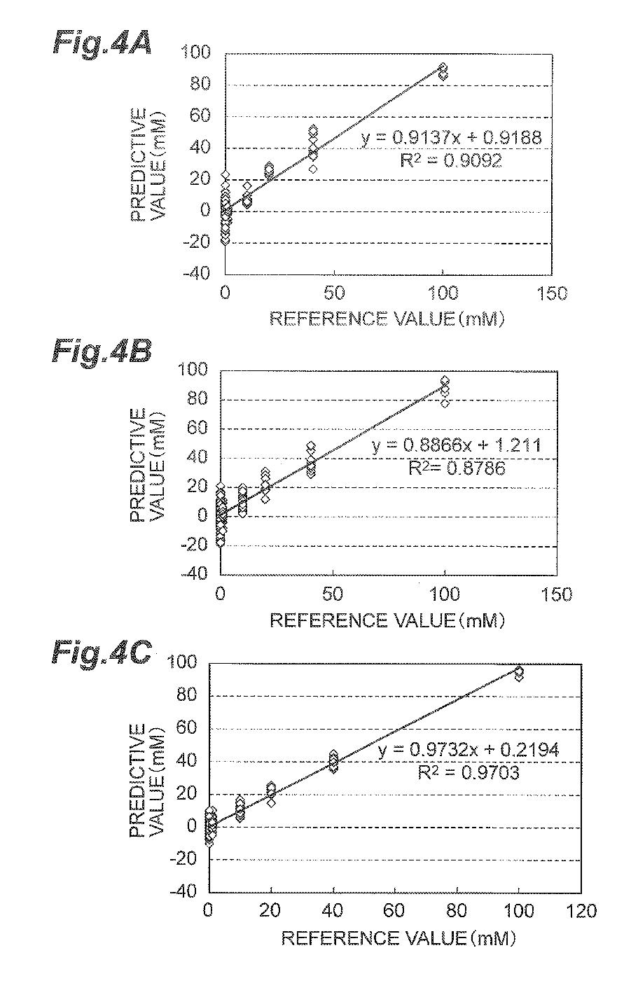

The results obtained by investigating the correspondence between the concentration of the fermentation inhibitors of a saccharified solution of which the concentration is known and the concentration of the fermentation inhibitors computed based on the absorption spectrum obtained using the method described above are shown. FIGS. 4A to 4C show the results obtained by preparing a plurality of types of saccharified solutions of which the concentration of formic acid serving as a fermentation inhibitor is known (0 mM, 10 mM, 20 mM, 40 mM, and 100 mM), acquiring hyperspectral images thereof using the optical measuring device 1 described above to obtain absorption spectra for respective pixels, and computing concentrations by performing multivariate analysis on the spectrum of a specific wavelength range among the respective absorption spectra. FIG. 4A is a graph showing the correspondence between reference values and predicted values of the formic acid when the analysis wavelength is set in the range of 1550 nm to 1800 nm, FIG. 4B is a graph showing the correspondence thereof when the analysis wavelength is set in the range of 2150 nm to 2300 nm, and FIG. 4C is a graph showing the correspondence thereof when the analysis wavelength is set in the ranges of 1550 nm to 1800 nm and 2150 nm to 2300 nm. It should be noted that, in FIGS. 4A to 4C, the horizontal axes represent the reference values that are the concentrations of the formic acid in the saccharified solutions, and the vertical axes represent the concentrations of the formic acid computed from the absorption spectra obtained by radiating near-infrared light. It should be noted that FIGS. 4A to 4C show the results obtained by plotting results of all pixels, performing multiple regression analysis with the plotted data, and then approximating the result with a linear function. In addition, under the conditions shown in FIG. 4A, root mean square error (RMSE)=7.1 mM, under the conditions shown in FIG. 4B, RMSE=8.2 mM, and under the conditions shown in FIG. 4C, RMSE=4.0 mM. As shown in FIGS. 4A to 4C, it was found that the concentration of the formic acid computed from the spectra that are obtained by measuring near-infrared light has a high correlation with real values of the concentration of the formic acid included in the saccharified solutions. In addition, it was found that, when the evaluation target is formic acid, the RMSE is smaller and measurement accuracy is higher when analysis is performed using the wavelength band of 1550 nm to 1800 nm than when analysis is performed using the wavelength band of 2150 nm to 2300 nm. Furthermore, it was found that the RMSE is even smaller and the measurement accuracy is further improved when both wavelength bands of 1550 nm to 1800 nm and 2150 nm to 2300 nm are used.

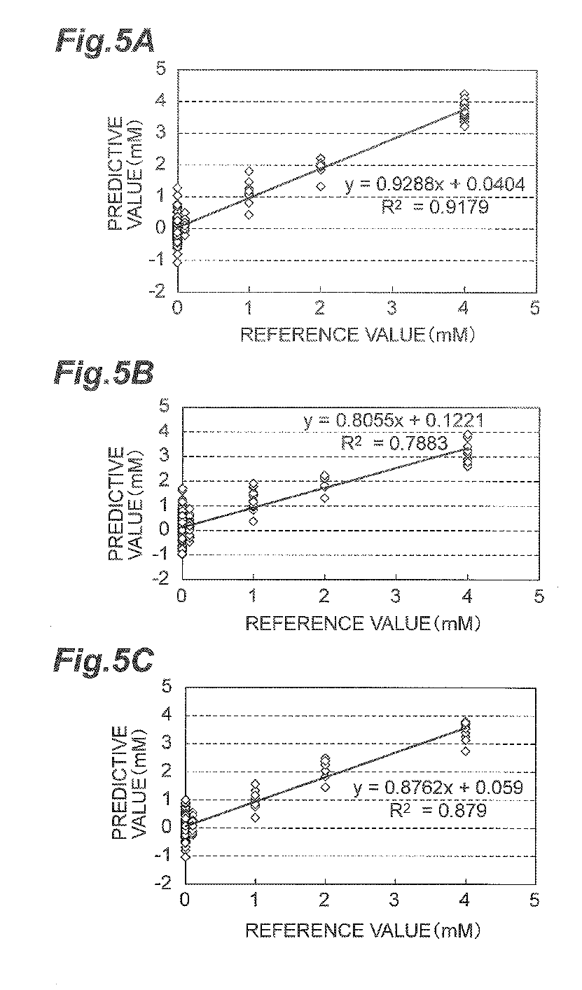

Next, FIGS. 5A to 5C show graphs in which, using furfural as a fermentation inhibitor, the correspondence between the known concentration of the fermentation inhibitor and the concentration of the fermentation inhibitor computed based on the absorption spectra obtained using the method described above was evaluated in the same way as in the case of the formic acid. Under the conditions shown in FIG. 5A, RMSE=0.35 mM, under the conditions shown in FIG. 5B, RMSE=0.56 mM, and under the conditions shown in FIG. 5C, RMSE=0.42 mM. As shown in FIGS. 5A to 5C, it was found that the concentration of furfural computed from the spectra obtained by measuring near-infrared light has a high correlation with the real concentration value of furfural included in the saccharified solutions. In addition, it was found that, when the evaluation target is furfural, the RMSE is smaller and measurement accuracy is higher when analysis is performed using the wavelength hand of 1550 nm to 1800 nm than when analysis is performed using the wavelength band of 2150 nm to 2300 nm. In addition, it was found that, with respect to the analysis result obtained using the wavelength band of 1550 nm to 1800 nm, the RMSE is even smaller and the measurement accuracy is further improved than when both wavelength bands of 1550 nm to 1800 nm and 2150 nm to 2300 nm are used. This is considered to be due to the characteristic peak of furfural formed near the wavelength of 1626 nm.

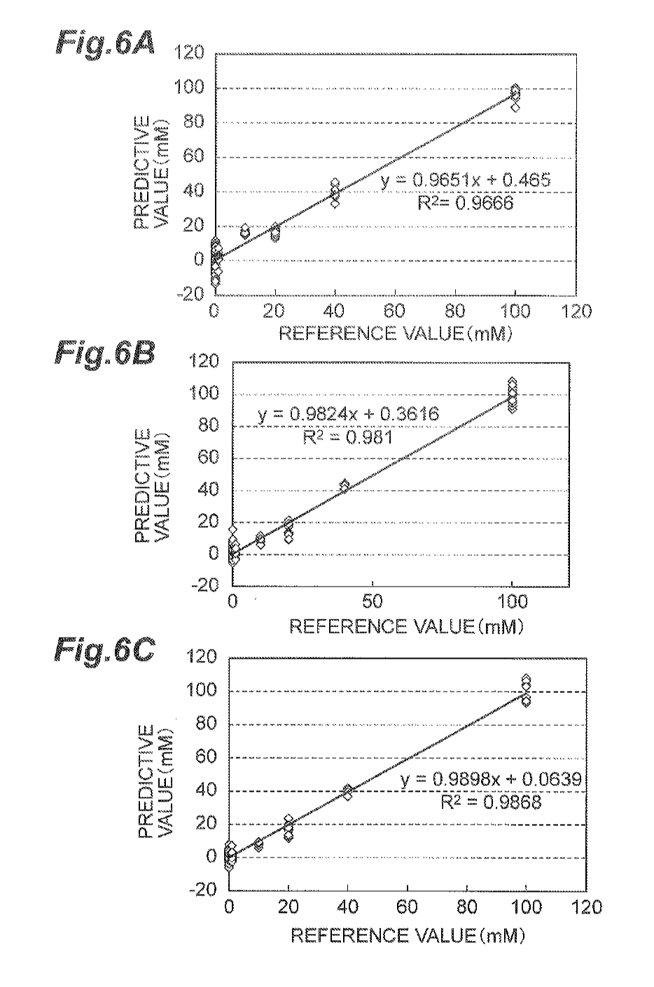

Furthermore, FIGS. 6A to 6C shows graphs in which, using acetic acid as a fermentation inhibitor, the correspondence between the known concentration of the fermentation inhibitor and the concentration of the fermentation inhibitor computed based on the absorption spectra obtained using the method described above was evaluated in the same way as in the case of the formic acid. Under the conditions shown in FIG. 6A, RMSE=5.2 mM, under the conditions shown in FIG. 6B, RMSE=4.1 mM, and under the conditions shown in FIG. 6C, RMSE=3.4 mM. As shown in FIGS. 6A to 6C, it was found that the concentration of acetic acid computed from the spectra obtained by measuring near-infrared light has a high correlation with the real concentration value of acetic acid included in the saccharified solutions. In addition, it was found that, when the evaluation target is the acetic acid, the RMSE is smaller and measurement accuracy is higher when analysis is performed using the wavelength band of 2150 nm to 2300 nm than when analysis is performed using the wavelength band of 1550 nm to 1800 nm. Furthermore, it was found that the RMSE is even smaller and the measurement accuracy is improved more when both wavelength bands of 1550 nm to 1800 nm and 2150 nm to 2300 nm are used.

As described above, according to the optical measuring method using the optical measuring device 1 of the present embodiment, it is possible to compute the amount of fermentation inhibitors based on a transmission spectrum obtained by the detection unit 20 by radiating neap-infrared light from the light source 10 to the measurement target 40 which includes a biomass-derived fermentation raw material. In addition, with the method described above, measurement can be performed with a simpler operation than when a measuring method such as the HPLC method is used as in the past. Moreover, when a biomass-derived fermentation raw material is used as a measurement target, preparation, for example, mixing the material with a drug, is unnecessary and further evaluation can be performed simply using the method described above.

In addition, in the computation step, it is possible to compute the concentration of fermentation inhibitors with higher accuracy by adopting application of multivariate analysis. It should be noted that, as multivariate analysis that can be used in the computation step, multiple regression analysis, principal component analysis, and the like are exemplified.

Although the embodiment of the present invention has been introduced in detail above, the present invention is not limited thereto, and can be variously modified. For example, in the embodiment described above, the configuration in which a transmission spectrum is converted into an absorption spectrum and then the amount of a target substance is computed has been described; however, a configuration in which a diffuse reflection spectrum is acquired, an absorption spectrum is computed from the diffuse reflection spectrum, and thereby the concentration of fermentation inhibitors is computed may be adopted.

In addition, although the case in which cellulose-based biomass is the raw material has been described in the embodiment described above, other kinds of biomass materials, for example, starch-based biomass, algae-based biomass, and the like can also be applied. In such a case, as fermentation inhibitors, formic acid, acetic acid, furfural, and the like are exemplified.

In addition, although evaluation is performed using absorption spectra in the embodiment described above, a configuration in which the concentration of fermentation inhibitors is computed directly from a transmission spectrum (or diffuse reflection spectrum) may be employed. Furthermore, a configuration in which any second order differential spectrum among an absorption spectrum, a diffuse reflection spectrum, and a transmission spectrum is obtained and then the concentration of fermentation inhibitors is computed using the spectrum may be employed. That is to say, with respect to the method for computing the concentration of fermentation inhibitors from a spectrum obtained by radiating near-infrared light, various techniques can be used.

In addition, the wavelength range of near-infrared light radiated by the light source 10 can be appropriately changed in the embodiment described above. For example, for the purpose of measuring only a specific fermentation inhibitor (for example, formic acid only), measurement can also be performed by selecting a plurality of wavelength ranges, in addition to narrowing the wavelength range of near-infrared light radiated from the light source 10. Since the formic acid, for example, has the characteristic peak near the wavelengths of 1777 nm and 2159 nm, the concentration of the formic acid can be computed using light of a relatively narrow band that is included in the range of ±6 nm of the wavelength of each peak. In addition, since the furfural has the characteristic peak near the wavelength of 1626 nm, the concentration of the furfural can be computed using light of a relatively narrow band that is included in the range of ±6 nm of the wavelength of the peak. In addition, since the acetic acid has the characteristic peaks at the wavelengths of 1683 nm, 1727 nm, and 2259 nm, the concentration of the acetic acid can be computed using light of a relatively narrow band that is included in the range of ±6 nm of the wavelength of each peak. However, when a wavelength range is set to be narrow, more accurate measurement can be performed by radiating near-infrared light in the range of at least 100 nm before and after the wavelength that is considered to have an absorption peak. In addition, as shown in FIGS. 4 to 6, even more accurate measurement can be performed when multivariate analysis is performed also using spectrum information not only of a wavelength band around the peak but also of peripheral wavelength bands.

What is claimed is:

1. An optical measuring method for measuring a concentration of a fermentation inhibitor included in a biomass-derived fermentation raw material, the method comprising:
acquiring a diffuse reflection spectrum or a transmission spectrum relating to a measurement target which includes the biomass-derived fermentation raw material by radiating near-infrared light to the measurement target; and
computing the concentration of the fermentation inhibitor based on the diffuse reflection spectrum or the transmission spectrum.

2. The optical measuring method according to claim 1, wherein the near-infrared light includes light with a wavelength that is included at least in the wavelength range of 1550 nm to 1800 nm.

3. The optical measuring method according to claim 1, wherein
the computing the concentration comprises computing the concentration of the fermentation inhibitor with multivariate analysis.

4. The optical measuring method according to claim 1, wherein the fermentation raw material is a saccharified solution obtained by saccharifying cellulose.

5. A manufacturing method of an alcohol, the method comprising:
the optical measuring method according to claim 1, and
adjusting, based on the concentration of the fermentation inhibitor, a condition of a pre-treatment step performed before obtaining the fermentation raw material or a fermentation condition of the fermentation raw material.

6. The manufacturing method of an alcohol according to claim 5, wherein the fermentation inhibitor includes formic acid, furfural, or acetic acid.
